(19) United States
(12) Patent Application Publication
(10) Pub. No.: US 2006/0096176 A1
(43) Pub. Date: May 11, 2006

(54) Closing device

(75) Inventors: Ingo Greuel, Muenchen (DE); Eckart Schuler, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignees: DaimlerChrysler AG, Stuttgart (DE); VALEO Sicherheitssysteme GMBH, Erdweg (DE)

(21) Appl. No.: 10/522,949

(22) PCT Filed: Jul. 17, 2003
(86) PCT No.: PCT/EP03/07755

§ 371 Date: Sep. 27, 2005

(30) Foreign Application Priority Data
Aug. 2, 2002 (DE) 102 35 608.4

(51) Int. Cl. E05F 11/00

(52) U.S. Cl. 49/324

(57) ABSTRACT

The present invention relates to a closing device for drawing shut a door, flap or hood or a lid, in particular a rear lid of a motor vehicle. A closing bracket carrier has a closing bracket and is mounted on a bearing plate in a manner such that it can be displaced by means of a driving device between a standby position, in which the closing bracket is extended, and a closing position, in which the closing bracket is retracted. Whereas the bearing plate is provided for fastening to a front side of a closing bracket retaining section of a frame of the door, flap or hood or of the lid, the driving device is provided for fastening to a rear side of the closing bracket retaining section. The closing bracket retaining section is, for its part, provided for the fastening of a fixed closing bracket, so that either the fixed closing bracket or the closing device can be fastened to the closing bracket retaining section.

This application claims the priority of PCT/EP03/07755 filed Jul. 17, 2003 which claims priority to Germany Application No. 102 35 608.4, filed Aug. 2, 2002 which are expressly incorporated by reference herein.

### BACKGROUND OF THE INVENTION

The present invention relates to a closing device for drawing shut a door, flap or hood or a lid, in particular a rear lid of a motor vehicle.

A passenger car, in particular, generally has two or four side doors, an engine hood and a rear lid or a rear door which are in each case equipped with a lock which, for the purpose of closing the particular flap or door or the particular lid, interacts with a closing bracket which is fitted on a frame of the particular door or of the particular lid. In the case of comfortable vehicles, one of the side doors or the tailgate can be equipped with a closing device which facilitates the drawing of the particular door or flap into the closing position. In order to close the rear lid or the side door, the user has to pivot them to only until the lock can interact with the closing bracket. The remaining closing movement is then carried out automatically and independently by the closing device.

A closing device of this type is advantageously fitted in a vehicle in conjunction with a driving device of a vehicle door (e.g., door, tailgate or rear lid), so that this driving device pivots the door until the lock interacts with the closing bracket and the closing device then draws the door counter to the force of the deforming door seal into the closing position.

DE 39 00 508 A1 discloses a closing device of the aforementioned type and has a closing bracket carrier which carries a closing bracket and can be displaced between a standby position, in which the closing bracket is extended, and a closing position, in which the closing bracket is retracted. Furthermore, a driving device is provided which drives the closing bracket carrier in order to displace it between the standby position and the closing position. In the case of the known closing device, the closing bracket carrier has a protruding pin which can be displaced in a sliding manner in a guide groove. This guide groove is formed to a slide which is mounted in a manner so that it can be displaced transversely with respect to the displacement movement of the closing bracket or of the closing bracket carrier, and forms part of the driving device. In this device, the guide groove is shaped so that the closing bracket carrier, which is positively coupled thereto via the pin, can be moved between the standby position and the closing position during a displacement movement of the slide. The slide is driven in one direction with the aid of a cable pull and in the other direction with the aid of a restoring spring. The displacement movement of the closing bracket or of the closing bracket carrier takes place in a purely translatory manner. For this purpose, the closing bracket carrier is mounted in a bidirectionally displaceable manner on a console which is fastened to the frame of the rear lid. The slide is also mounted on this console. The cable pull for actuating the slide leads to a motor which is accommodated on a side wall in the trunk.

DE 42 30 985 C2 discloses another known closing device of the aforementioned type in and likewise comprises a closing bracket carrier which has a closing bracket and can be displaced between a standby position in which the closing bracket is extended, and a closing position in which the closing bracket is retracted. A driving device, also with a cable pull and a restoring spring, drives the closing bracket carrier in order to displace it between the standby position and the closing position. In this embodiment too, the closing bracket carrier is mounted in a bidirectionally displaceable manner on a console. The closing bracket carrier is provided with a pin which engages in a guide slot. This guide slot is formed in a guide lever which is mounted pivotably on the console. The guide lever forms part of the driving device, with the cable pull, on the one hand, and the restoring spring, on the other hand, engaging on the guide lever. The console is fastened to the frame of the rear lid, that is to the edge of the trunk opening. A motor of the driving device is arranged at a distance therefrom at another suitable location in the trunk. In order to displace the closing bracket carrier, the guide lever is pivoted via the cable pull or via the restoring spring, in which case the closing bracket carrier, which is positively coupled to it via the guide slot and the pin, is displaced in a corresponding manner between its closing position and its standby position.

The construction of the known closing devices is relatively complicated; in particular, the known closing devices require a relatively high installation outlay. A particular disadvantage of the known closing devices is the fact that they require in each case a relatively large installation space, with the consequence that the vehicle equipped therewith requires a special manufacturing process in the region of the frame which is designed for fastening the console. For the situation in which a closing device of this known type is to be installed in the particular vehicle only as a special feature, this results in relatively high costs because the frame which is provided for the attachment of a standard, fixed closing bracket is not suitable for the attachment of the closing device or of the console thereof.

### SUMMARY OF THE INVENTION

An object of the present invention is to overcome the problem of specifying, for a closing device of the aforementioned type by providing, an improved device which, in particular, can be installed more easily and less expensively, and which permits better standardization particularly with regard to fixed closing brackets of the same vehicle model.

This problem has been solved according to the present invention based on the general recognition of using, for the fastening of the closing device, a closing bracket retaining section which is formed on the frame of the door, flap or hood or of the lid and is provided for the fastening of a standard, fixed closing bracket, for which purpose the closing device is adapted in a suitable manner to this closing bracket retaining section.

According to the present invention, this adaptation takes place by the closing bracket carrier being mounted on a bearing plate which is configured for fastening to a front side of the closing bracket retaining section while the driving device is configured for fastening to a rear side of the closing bracket retaining section. The functional separation of the closing bracket carrier from the driving device enables the two components to be fitted on both sides of the closing bracket retaining section, thus making it possible, in particular, for construction space to be saved.

The adaptation of the closing device, which is conceived as a special feature, to the closing bracket retaining section, which is provided for a standard feature, makes it possible, during installation, either to attach the standard, fixed closing bracket or the closing device of the special feature to the closing bracket retaining section. Because no changes are therefore required on the bodywork, the closing device according to the present invention can be realized on a vehicle at reasonable cost.

According to one currently particularly advantageous embodiment, the closing bracket carrier can be mounted rotatably on the bearing plate and can be displaced between the standby position and the closing position by pivoting about a pivot axis. In this case, the closing bracket carrier has a driving arm which, with respect to the closing bracket, protrudes from the closing bracket carrier in a direction away from the pivot axis on a side of the closing bracket carrier that faces away from the pivot axis. In this embodiment, the driving device is provided with a driving element which is fastened to a carrier plate and interacts with an end section of the driving arm, which section is remote from the pivot axis, in order to pivot the closing bracket carrier.

The carrier plate has a supporting arm which protrudes from the carrier plate in the direction of the pivot axis, with a supporting arm end section which is remote from the driving element being provided for fastening to the rear side of the closing bracket retaining section. By virtue of these measures, a rotatory displacement movement about an eccentric pivot axis is produced for the closing bracket. This novel kinematics arrangement permits the use of other, hitherto unusable driving elements, as a result of which the complete closing device can be of very compact construction and, in particular, is fastened in complete form—apart from switches, cables, power supply—to the closing bracket retaining section and, in particular, can be accommodated in the frame of the particular flap or hood or of the particular lid.

According to one feature of the present invention, in the fitted state, the closing bracket retaining section, the bearing plate, the closing bracket carrier, the driving arm, the carrier plate and the supporting arm can extend in each case essentially parallel to a plane which runs perpendicularly with respect to the pivot axis. This permits a particularly flat construction of the closing device. In this sense, “flat” is understood to mean a relatively small dimension in the direction of the pivot axis; in particular, the closing device is smaller parallel to the pivot axis than transversely thereto.

A further advantageous embodiment is characterized in that, in the fitted state, the driving element, the supporting arm and the driving arm are arranged essentially along or in the vicinity of a straight line. These measures produce a relatively long stretched-out construction for the closing device. That is, the closing device is considerably larger in the direction of this straight line than transversely thereto. This construction makes it possible for the closing device according to the present invention to be accommodated particularly easily in a cavity in the frame of the particular lid or of the particular door or hood.

It should be clearly understood that the features mentioned above and those which will be explained in detail below can be used not only in the respectively stated combination, but also in other combinations or on their own without departing from the spirit of the present invention.

### BRIEF DESCRIPTION OF THE DRAWINGS

Other objects, advantages and novel features of the present invention will become apparent from the following detailed description of the invention when considered in conjunction with the accompanying drawings.

FIG. 1 is a side view of an assembled closing device in accordance with the present invention,

FIG. 2 is an isolated view of a driving device of the closing device shown in FIG. 1,

FIG. 3 is an isolated view of a closing bracket carrier of the closing device shown in FIG. 1,

FIG. 4 is a side view of the closing device of FIG. 1 fitted into a frame,

FIG. 5 is a perspective detail view of the closing device shown in FIG. 4 but in a different viewing direction,

FIG. 6 is a view similar to FIG. 5, but with a fixed closing bracket,

FIG. 7 is a perspective isolated view of the closing bracket shown in FIG. 6, and

FIG. 8 is a perspective isolated view of a retaining plate of the closing bracket shown in FIG. 6.

### DETAILED DESCRIPTION OF THE DRAWINGS

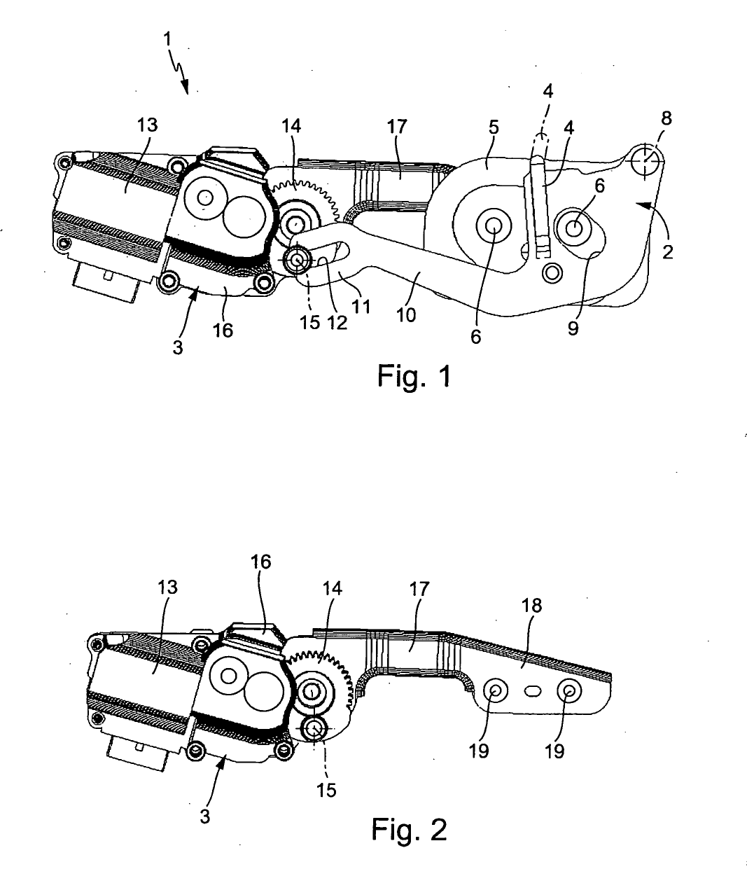

As seen in FIG. 1, a closing device 1 includes a closing bracket carrier 2 and a driving device 3. With the aid of the closing device 1, a conventional lid, door flap or hood (not illustrated), in particular of a motor vehicle, can be drawn shut. The closing device 1 is preferably used in a passenger car for drawing shut the rear lid or trunk lid or the rear door. In principle, it is also contemplated for it to be used in a vehicle side door.

The closing bracket carrier 2 has a closing bracket 4 and can be displaced between the closing position (shown in FIGS. 1, 3 and 5) and a standby position, which is raised with respect to the position of the closing bracket 4 and is indicated in FIG. 1 by an interrupted or dashed line. Accordingly, in the standby position the closing bracket 4 is in a raised or extended state while, in the closing position, it takes up a retracted or lowered position. The closing bracket 4 interacts in a conventional manner with a lock which is accommodated in the particular door, flap or hood or in the particular lid. The driving device 3 is coupled in terms of drive to the closing bracket carrier 2 and drives the latter in order to displace it between the standby position and the closing position.

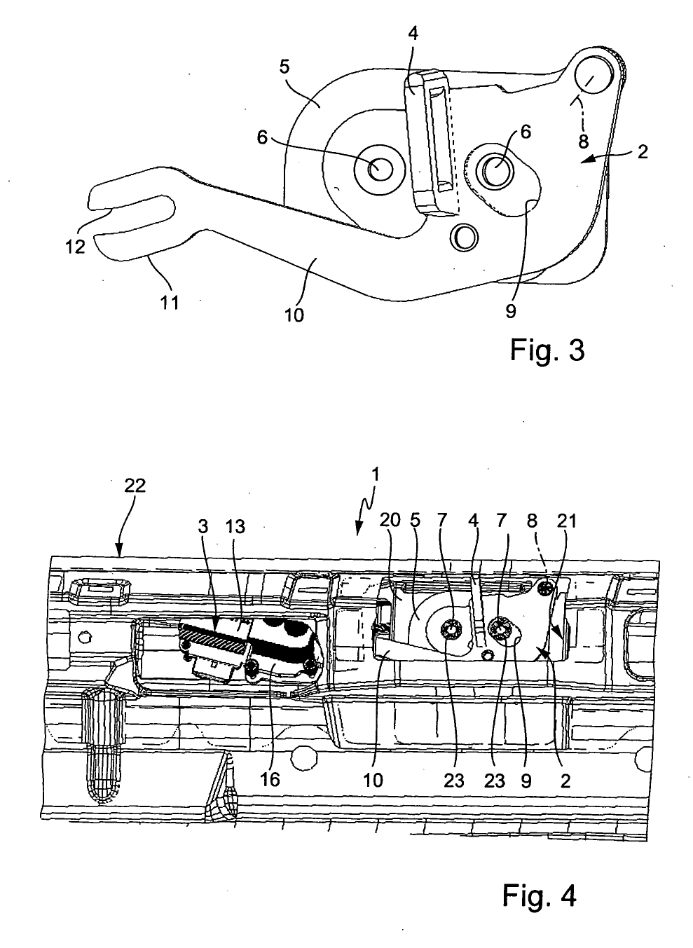

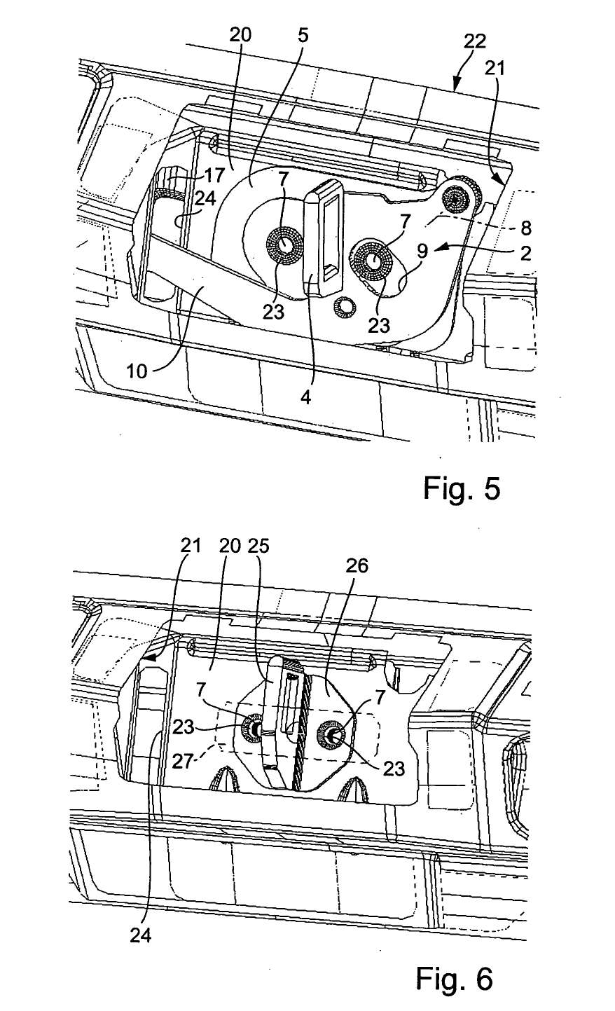

According to FIGS. 1 and 3, the closing bracket support 2 is mounted on a bearing plate 5 which has at least one (two as illustrated), plug-in openings 6 into which fastening screws 7 (cf. FIGS. 4 and 5) can be inserted. In the illustrated embodiment, the closing bracket carrier 2 is mounted on the bearing plate 5 to rotate about a pivot axis 8, so that the closing bracket carrier 2 can be displaced by pivoting between the standby position and the closing position via rotational movement. The desired displacement travel for the closing bracket 4 is produced by a corresponding, eccentric arrangement of the same.

For at least one of the fastening screws 7, the closing bracket carrier 2 contains an advantageously elongated-hole-shaped aperture 9 which is shaped in such that, in each relative position of the closing bracket carrier 2, one of the plug-in openings 6 is overlapped to allow that the associated fastening screw 7 (cf. FIGS. 4 and 5) to be fitted and is accessible through this aperture 9.

The closing bracket carrier 2 has a driving arm 10 which protrudes from the closing bracket carrier 2 in a direction leading away from the pivot axis 8. The driving arm 10 and pivot axis 8 are formed, with respect to the closing bracket 4, on mutually opposite sides of the closing bracket carrier 2. On its end section 11 facing away from or remote from the pivot axis 8, the driving arm 10 has a fork-like configuration 12.

The closing bracket carrier 2 is constructed so that it extends, apart from the closing bracket 4, in a plane which runs perpendicularly with respect to the pivot axis 8, and is situated parallel to the plane of the drawing. The closing bracket 4 protrudes from the closing bracket carrier 2 perpendicularly with respect to this plane, i.e. parallel to the pivot axis 8. Furthermore, the fork 12, the closing bracket 4 and the pivot axis 8 lie essentially on a straight line which is not referred to specifically here.

According to FIGS. 1 and 2, the driving device 3 has a driving element 13 in the form of, for example, an electric motor with a gear mechanism. The driving element 13 also comprises here a segmented gearwheel 14 on which a pin 15 is formed eccentrically with respect to the rotation axis of the gearwheel 14. During a rotational displacement of the gearwheel 14, the pin 15 moves correspondingly on a circular path. In the assembled state according to FIG. 1, this pin 15 engages in the fork end 12. A rotation of expediently 180° permits, the gearwheel 14 to pivot the closing bracket carrier 2, which is positively coupled thereto, between the closing position and the standby position.

The driving element 13 is fastened to a carrier plate 16 of the driving device 3. The carrier plate 16 has a supporting arm 17 which, in the assembled state of FIG. 1, protrudes from the carrier plate 16 in the direction of the pivot axis 8. On its end section 18 facing away from the driving element 13, the supporting arm 17 has, for each fastening screw 7 (cf. FIGS. 4 and 5), a threaded opening 19 into which the particular fastening screw 7 can be screwed. The driving element 13, in particular also the gearwheel 14, the carrier plate 17 and the end section 18 thereof, are expediently also oriented here with respect to a straight line. Furthermore, the carrier plate 17 extends essentially likewise in a plane which runs perpendicularly with respect to the pivot axis 8 and therefore parallel to the plane of the drawing.

In the assembled state shown in FIG. 1, the pin 15, which engages in the fork end 12, the fork end 12 itself, the closing bracket 4 and the pivot axis 8 lie essentially on a straight line.

Referring now to FIG. 4, the closing device 1 is installed in a closing bracket retaining section 20 which is formed in a cutout 21 in or on a frame 22 of the door, flap or hood or of the lid which is to be drawn shut with the aid of the closing device 1. In this illustrated embodiment, the frame 22 forms the boundary of an opening which can be closed with the aid of the particular lid or with the aid of the particular flap, lid or door in a generally known manner. For example, the frame 22 forms the rear boundary of a trunk or loading compartment.

According to the present invention, the closing device 1 is installed so that the bearing plate 5 is fastened to a front side of the closing bracket retaining section 20, which front side faces the observer in FIGS. 4 and 5. In contrast thereto, the driving device 3 is fastened via the free end section 18 of the supporting arm 17 to a rear side of the closing bracket retaining section 20, which rear side faces away from the observer. For this purpose, the closing bracket retaining section 20 contains, for each fastening screw 7, a passage opening 23 into which the particular fastening screw 7 can be inserted. The bearing plate 5 and the supporting arm 17 are fastened via the fastening screws 7 by the latter being inserted from the side facing the observer into the plug-in openings 6 of the bearing plate 5, through the passage openings 23 of the closing bracket retaining section 20 and into the threaded openings 19 of the free end section 18 of the supporting arm 17 and being screwed therein. The aperture 9, which has already been described above, is the feature through which a fastening screw 7 is accessible and can be fitted.

So that the screwing of the bearing plate 5 and of the supporting arm 17 to the closing bracket retaining section 20 works, the arrangement of the plug-in openings 6 and of the threaded openings 19 is formed congruently to the arrangement of the passage openings 23.

As is particularly clearly seem in FIGS. 1 and 4, in the fitted state, the closing bracket retaining section 20, the bearing plate 5, the closing bracket carrier 2, the driving arm 10, the carrier plate 16 and the supporting arm 17 in each case run essentially parallel to one another and accordingly essentially perpendicularly with respect to the pivot axis 8, i.e., at least in FIG. 1, also parallel to the plane of the drawing. Accordingly, the closing device 1 according to the present invention is of relatively flat construction in the assembled state, i.e. the fitted closing device 1 is of a relatively small size in the direction of the pivot axis 8, in particular is smaller than in the directions running transversely with respect to the pivot axis 8.

Furthermore, it can be seen relatively easily from FIGS. 1 and 4 that, in the fitted state, an essentially rectilinear orientation is produced for the driving element 13, the carrier plate 16 and the closing bracket carrier 2. Accordingly, the driving element 13, the supporting arm 17 and the driving arm 10 are arranged essentially along or in the vicinity of a straight line. This results in a long stretched-out construction for the closing device 1, i.e. the extent of the closing device 1 in this longitudinal direction is significantly larger than transversely thereto.

Overall, the proposed construction results in a relatively low requirement for construction space, with the result that, in particular, the closing device 1, as here can be accommodated, in the frame 22.

Referring to FIG. 5, a window 24 is provided in the region of the cut-out/recess 21 and the driving arm 10 is guided through the window to the driving device 3.

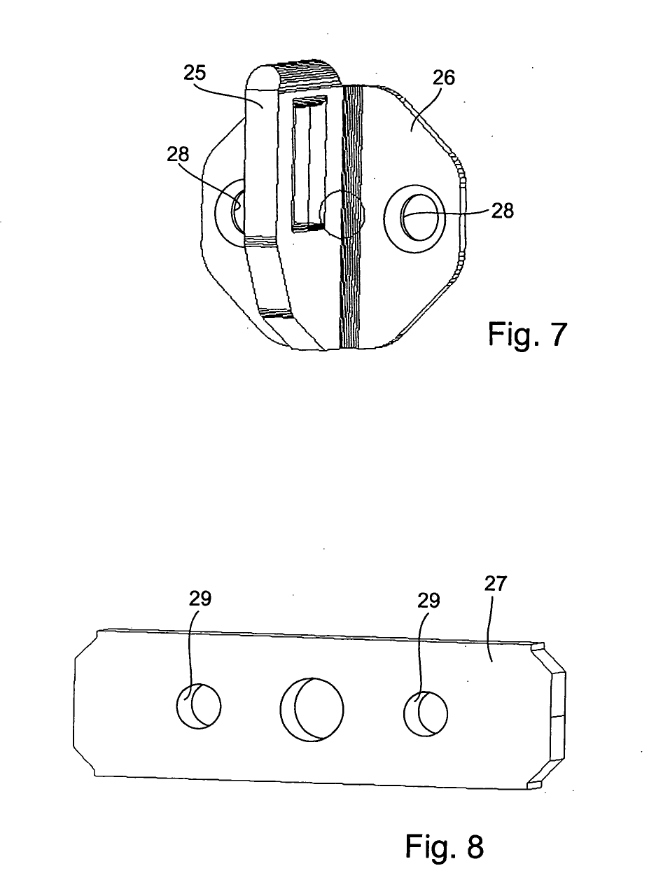

FIG. 6 shows the same detail of the frame 22 in which is formed the cut-out/recess 21 in which the closing bracket retaining section 20 of the frame 22 is arranged. Instead of the closing device 1 according to the present invention, a conventional, fixed closing bracket 25 is fastened in FIG. 6 to this closing bracket retaining section 20. In this instance, the fixed closing bracket 25 is formed on a retaining plate 26 which is fitted to the front side of the closing bracket retaining section 20, which front side faces the observer. A fastening plate 27 (illustrated by an interrupted or dashed line) is fitted to the rear side of the closing bracket retaining section 20, which rear side faces away from the observer as seen in FIGS. 7 and 8, the retaining plate 26 is also provided with two plug-in openings 28 while the fastening plate 27 contains two threaded openings 29. The plug-in openings 28 and the threaded openings 29 are again arranged congruently to the passage openings 23 of the closing bracket retaining section 20, so that the retaining plate 26 together with the fastening plate 27 can be screwed against the closing bracket retaining section 20 with the aid of the fastening screws 7 (cf. FIG. 6).

The closing device 1 should be configured such that it can be fastened instead of the fixed closing bracket 25 or instead of the retaining plate 26 and the fastening plate 27 to the closing bracket retaining section 20. In the currently preferred embodiment shown here, the closing device 1 uses the two passage openings 23 of the closing bracket retaining section 20, which openings are provided per se for the attachment of the fixed closing bracket 25.

Whereas the fixed closing bracket 25 can be a feature of a motor vehicle that is provided as standard, the closing device 1 generally forms a special feature variant. Because no changes have to be carried out to the frame 22 or to the closing bracket retaining section 20 when the closing device 1 of the present invention is used, the closing device 1 can be fitted instead of the fixed closing bracket 25 in a particularly simple manner and at reasonable cost. In particular, the present invention also makes it possible to replace the fixed closing bracket 25 with the closing device 1 in the after-market.

The foregoing disclosure has been set forth merely to illustrate the invention and is not intended to be limiting. Since modifications of the disclosed embodiments incorporating the spirit and substance of the invention may occur to persons skilled in the art, the invention should be construed to include.

1.-11. (canceled)

12. A system having a fixed closing bracket and a closing device for drawing shut a door, flap, hood or a lid having a frame, wherein
(a) the fixed closing bracket has fastening openings arranged congruently to passage openings which contain a closing bracket retaining section of the frame;
(b) the closing device has a closing bracket carrier with a closing bracket and being displaceable between a standby position, in which the closing bracket is extended, and a closing position, in which a closing bracket is retracted,
(c) the closing device has a driving device arranged to drive the displace closing bracket carrier between the standby position and the closing position,
(d) the closing bracket carrier is mounted on a bearing plate so as to be displaceable between the standby position and the closing position, and
(e) the bearing plate has openings congruent to the fastening openings, whereby, it being possible, using the passage openings the closing device and optionally the fixed closing bracket are fastenable to the closing bracket retaining section.

13. The system as claimed in claim 12, wherein the bearing plate is fastenable to a front side of the closing bracket retaining section, and the driving device is fastenable to a rear side of the closing bracket retaining section.

14. The system as claimed in claim 12, wherein that the openings of the bearing plate are plug-in openings for fastening screws, the driving device has threaded openings for the fastening screws, and the plug-in openings and the threaded openings are arranged congruent to an arrangement of the passage openings formed in the closing bracket retaining section.

15. The system as claimed in claim 14, wherein the closing bracket carrier has at least one aperture configured to cover one of the plug-in openings and through which one of the fastening screws is fittable.

16. The system as claimed in claim 14, wherein the closing bracket carrier is rotatable mounted on the bearing plate and is displaceable between the standby position and the closing position about a pivot axis, the closing bracket carrier has a driving arm which, with respect to the closing bracket, protrudes away from the closing bracket carrier in a direction away from the pivot axis on a side of the closing bracket carrier that faces away from the pivot axis, the driving device has a driving element fastened to a carrier plate to interact with an end section of the driving arm, which section is remote from the pivot axis to pivot the closing bracket carrier, the carrier plate has a supporting arm protruding from the carrier plate in the direction of the pivot axis, and an end section of the supporting arm, which end section is remote from the driving element, is for fastenable to the rear side of the closing bracket retaining section.

17. The system as claimed in claim 16, wherein the driving element drives a pin on a circular path, and the end section of the driving arm has a fork for engaging the pin.

18. The system as claimed in claim 17, wherein in a fitted state, the pin, the fork, the closing bracket and the pivot axis lie essentially on a straight line.

19. The system as claimed in claim 16, wherein in a fitted state, the closing bracket retaining section, the bearing plate, the carrier plate and the supporting arm extend essentially parallel to a plane which runs perpendicularly with respect to the pivot axis.

20. The system as claimed in claim 19, wherein the driving element drives a pin on a circular path, and the end section of the driving arm has a fork for engaging the pin.

21. The system as claimed in claim 20, wherein in a fitted state, the pin, the fork, the closing bracket and the pivot axis lie essentially on a straight line.

22. The system as claimed in claim 16, wherein in a fitted state, the driving element, the supporting arm and the driving arm are arranged essentially along or in the vicinity of a straight line.

23. The system as claimed in claim 12, wherein the closing device is configured to be used to draw shut a motor vehicle rear lid.

24. The system as claimed in claim 12, wherein the fixed closing bracket is formed on a retaining plate which has the fastening openings configured as plug-in openings for fastening screws and a fastening plate has threaded openings for the fastening screws, whereby the retaining plate and the fastening plate are screwable against the closing bracket retaining section with the fastening screws.
